(19) United States
(12) Patent Application Publication
(10) Pub. No.: US 2026/0157291 A1
(43) Pub. Date: Jun. 11, 2026

(54) ADJUSTABLE HEIGHT IRRIGATION SPAN WITH FLEXIBLE JOINT ASSEMBLY

(71) Applicant: Valmont Industries, Inc., Omaha, NE (US)

(72) Inventor: Joseph Timmons, Omaha, NE (US)

(73) Assignee: Valmont Industries, Inc., Omaha, NE (US)

(21) Appl. No.: 19/407,122

(22) Filed: Dec. 3, 2025

Related U.S. Application Data
(60) Provisional application No. 63/730,509, filed on Dec. 11, 2024.

(51) Int. Cl. A01G 25/09

(52) U.S. Cl. CPC A01G 25/092

(57) ABSTRACT

An adjustable height irrigation span system to improve water distribution across diverse terrains and crop heights. This system includes a flexible joint assembly connecting at least a first and second irrigation span. The flexible joint assembly preferably allows at least one degree of freedom and preferably further includes an adjustable turnbuckle assembly for height modification.

### RELATED APPLICATIONS

The present application claims priority to U.S. Provisional Application No. 63/730,509 filed Dec. 11, 2024.

### BACKGROUND AND FIELD OF THE PRESENT INVENTION

### Field of the Present Invention

The present invention relates generally to irrigation machines and, more particularly, to an adjustable height irrigation span and flexible joint for use within a mobile irrigation machine.

### Background of the Invention

Modern field irrigation machines are combinations of drive systems and sprinkler systems. Generally, these systems are divided into two types depending on the type of travel they are designed to execute: center pivot and/or linear.

Regardless of being center pivot or linear, common irrigation machines most often include an overhead sprinkler irrigation system consisting of several segments of pipe (usually galvanized steel or aluminum) joined together and supported by trusses, mounted on wheeled towers with sprinklers positioned along its length. These machines move in a circular pattern (if center pivot) or linearly and are fed with water from an outside source i.e. a well or water line. The essential function of an irrigation machine is to apply an applicant (i.e. water or other solution) to a given location.

FIG. 1 illustrates an exemplary self-propelled irrigation system 100 as known in the prior art. As shown, common self-propelled irrigation systems 100 generally may include spans 102, 104, 106 supported by drive towers 108, 110, 112. Further, each drive tower 108, 110, 112 is shown with respective drive controllers 114, 116, 118. For each drive tower, 108, 110, 112, the respective drive controllers 114, 116, 118 may generally control respective drive motors 120, 122, 124 and drive wheels 126, 128, 130. Further, such irrigation machines 100 may generally include an extension/overhang 121 which may include an end gun (not shown).

Due to their substantial length and relatively lightweight, irrigation spans are particularly vulnerable to lateral forces exerted by strong winds, storms, and extreme weather conditions. In particular, high winds can exert significant lateral pressure on the span, creating a tipping or rolling hazard. This vulnerability is especially pronounced for spans positioned in open, flat fields where wind speeds can quickly escalate without obstruction.

Traditional approaches to mitigate this risk include manually deploying temporary stabilizers, tie-down systems, or anchoring points. However, such methods are labor-intensive, time-consuming, and often lack precision or reliability. Moreover, they require manual intervention, which is impractical during sudden or unexpected wind events, potentially resulting in substantial damage to the irrigation equipment.

To overcome the limitations of the prior art, a system is needed that can quickly and efficiently adjust and change the dimensions and height parameters of a given irrigation span.

### SUMMARY OF THE DISCLOSURE

To minimize the limitations found in the prior art, and to minimize other limitations that will be apparent upon the reading of the specifications, the present invention provides a multi-jointed articulable irrigation span that is able to quickly and efficiently adjust the height of the irrigation span during irrigation operations or when the system is not irrigating.

According to a first exemplary embodiment, the present invention provides an adjustable height irrigation span system including a central span with drive units, a flexible joint allowing rotational and angular adjustments, and a turnbuckle assembly for height modification. The span's height can be altered to better suit different field conditions, improving irrigation accuracy and efficiency.

According to a further preferred embodiment, the present invention includes an adjustable-length truss rod member that is arranged to be lengthened or shortened to raise or lower individual areas of a given span or the entire length of the span.

According to a further preferred embodiment, the present invention includes a cable, chain, rod, and other components capable of adjusting the length between truss rod supports. According to preferred embodiments, the present invention may include a hydraulic cylinder, linear actuator, or winch assembly (in place of the motor) that acts to change the length between truss rod supports.

According to a further preferred embodiment, the present invention may preferably include a torsional spring system to reduce the maximum torque required from the motor.

According to a further preferred embodiment, the present invention may further include a central controller that may process manual and/or sensor inputs and use the processed data to output commands to the drive and steering systems of the present invention to initiate height adjustments as determined by the system or operator of the system.

According to a further preferred embodiment, the present invention may include a controller that processes location information of the system and adjusts the height of the spans at predetermined locations in the field. For example, the GPS location of the system could be used to adjust the height of the spans to fit the contour of the field or crop height.

According to a further preferred embodiment, the present invention may include a controller that processes weather information, which may include wind or severe weather, and adjusts the height of the spans. For example, span heights could be lowered in the field to mitigate the chance of damage due to strong winds forecasted or measured at the system. If winds exceed a certain speed, the spans could automatically be lowered to prevent damage.

### BRIEF DESCRIPTION OF THE DRAWINGS

FIG. 1 shows an exemplary irrigation system of the prior art.

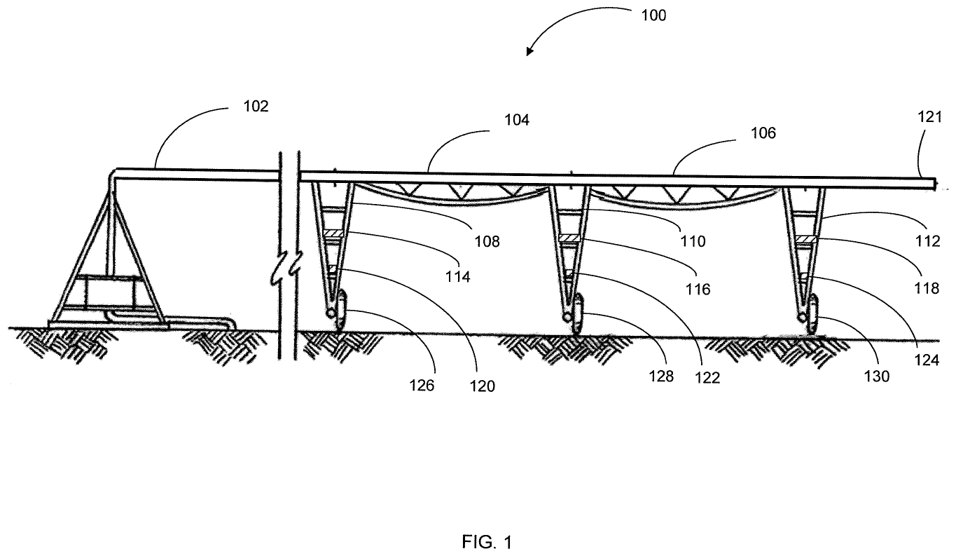

FIG. 2 shows an illustration of an exemplary irrigation span with an exemplary span flexible joint in accordance with a preferred embodiment of the present invention.

FIG. 3 is an enlarged view of the irrigation span indicated in FIG. 2.

FIG. 4 is an illustration of the exemplary irrigation span shown in FIG. 2 with the flexible joint of the present invention in a raised position.

FIG. 5 is an illustration of the exemplary irrigation span shown in FIG. 2 with the flexible joint of the present invention in a lowered position.

FIG. 6 is an enlarged view of the irrigation span of the present invention with the flexible joint in a lowered position.

FIG. 7 is a side view of an exemplary flexible joint assembly of the present invention within an exemplary span.

FIG. 8 is a perspective view of the exemplary flexible joint assembly of the present invention shown in FIG. 7.

FIG. 9 is a perspective view of an exemplary adjustable turnbuckle assembly in accordance with a preferred embodiment of the present invention.

FIG. 10 is a perspective view of an exemplary adjustable turnbuckle assembly within an exemplary irrigation span having an exemplary span flexible joint between connected spans in accordance with a preferred embodiment of the present invention.

### DESCRIPTION OF THE PREFERRED EMBODIMENTS

For the purposes of promoting an understanding of the principles of the present invention, reference will now be made to the embodiments illustrated in the drawings and specific language will be used to describe the same. It will nevertheless be understood that no limitation of the scope of the present invention is hereby intended, and such alterations and further modifications in the illustrated devices are contemplated as would normally occur to one skilled in the art. The descriptions, embodiments and figures used are not to be taken as limiting the scope of the claims.

Where the specification describes advantages of an embodiment or limitations of other prior art, the applicant does not intend to disclaim or disavow any potential embodiments covered by the appended claims unless the applicant specifically states that it is “hereby disclaiming or disavowing” potential claim scope. Moreover, the terms “embodiments of the invention”, “embodiments” or “invention” do not require that all embodiments of the invention include the discussed feature, advantage or mode of operation, nor that it does not incorporate aspects of the prior art which are sub-optimal or disadvantageous.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Additionally, any examples or illustrations given herein are not to be regarded in any way as restrictions on, limits to, or express definitions of, any term or terms with which they are utilized. Instead, these examples or illustrations are to be regarded as illustrative only.

As used herein, the singular forms “a”, “an” and “the” are intended to include the plural forms as well, unless the context clearly indicates otherwise. Additionally, the word “may” is used in a permissive sense i.e., meaning “having the potential to’, rather than the mandatory sense i.e., meaning “must”.

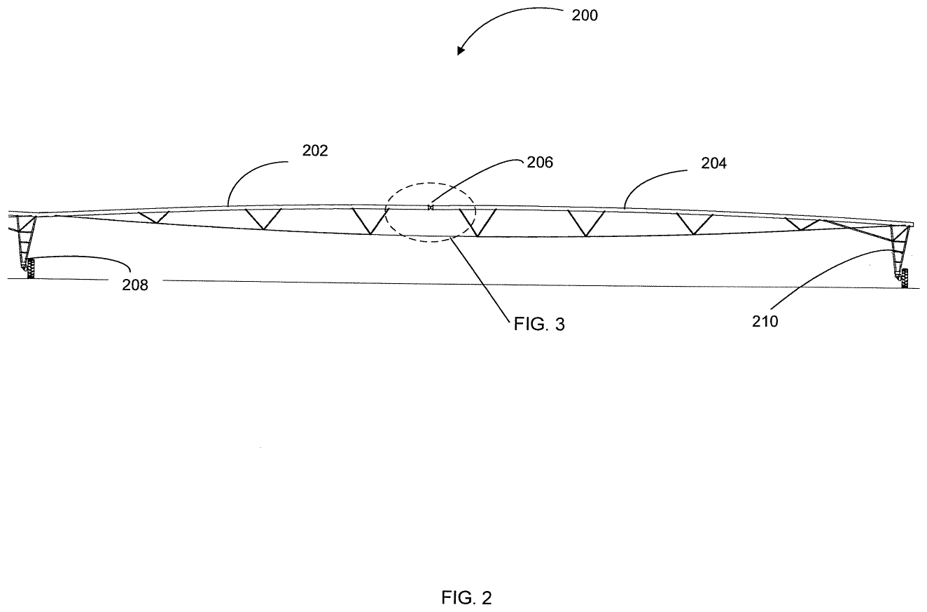

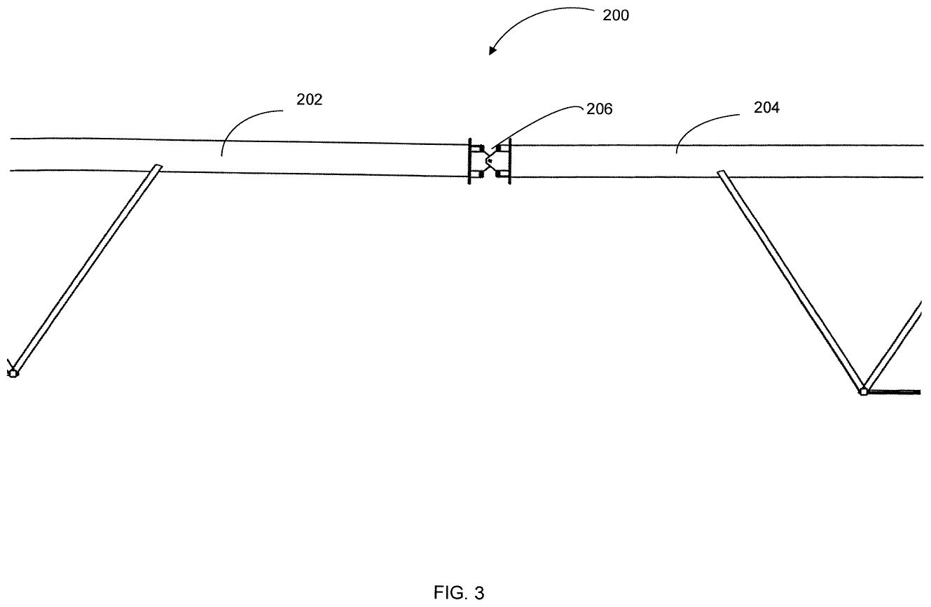

Referring now to FIGS. 2-6, a first set of embodiments illustrating aspects of the present invention shall now be discussed. Referring first to FIG. 2, an illustration of an exemplary adjustable height irrigation span 200 in accordance with a preferred embodiment of the present invention is provided. As shown, the irrigation span section 200 preferably includes a first span 202 supported by a first drive unit 208, and a second span 204 supported by a second drive unit 210. Between the first span 202 and the second span 204, a first flexible joint 206 is shown that enables the height adjustment to be applied to each span section 202, 204. FIG. 3 provides an enlarged view of the flexible joint assembly 206.

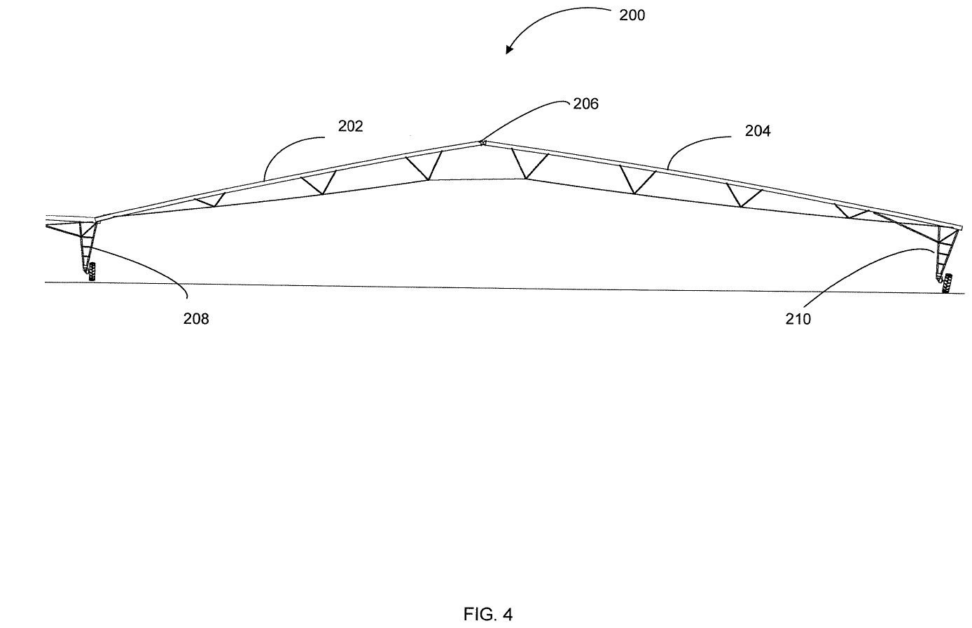

Referring to FIG. 4, the exemplary irrigation span 200 shown may preferably flex at the flexible joint assembly 206 to allow the connected spans 202, 204 to create a bend in the central flexible joint assembly 206. To allow this bend, one or more of the drive wheels 126, 128, 130 may preferably be arranged to bend or steer towards the central flexible joint assembly 206. For example, the irrigation drive tower 210 may preferably be a steerable drive unit SDU which may preferably be controlled to move a set distance, at a set angle to produce a targeted span height. Preferably, this adjustment may be performed by the drive tower controller, which may be controlled directly or via a central controller in response to a targeted span height 213 being selected by an operator. According to alternative embodiments, this adjustment may alternatively be made by adjustments to the camber of a given drive wheel for a set time period or travel distance to create or facilitate the targeted height adjustment.

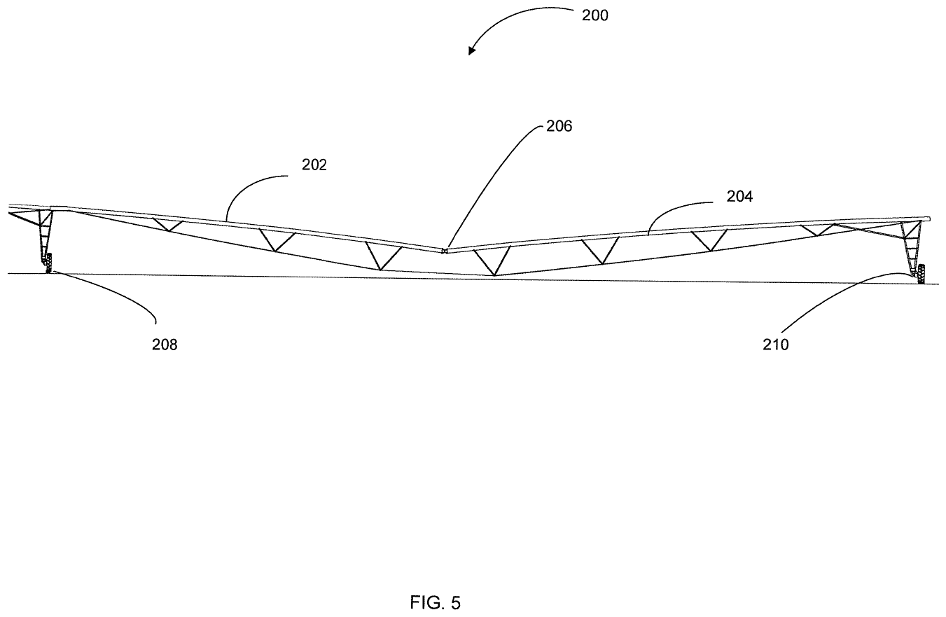

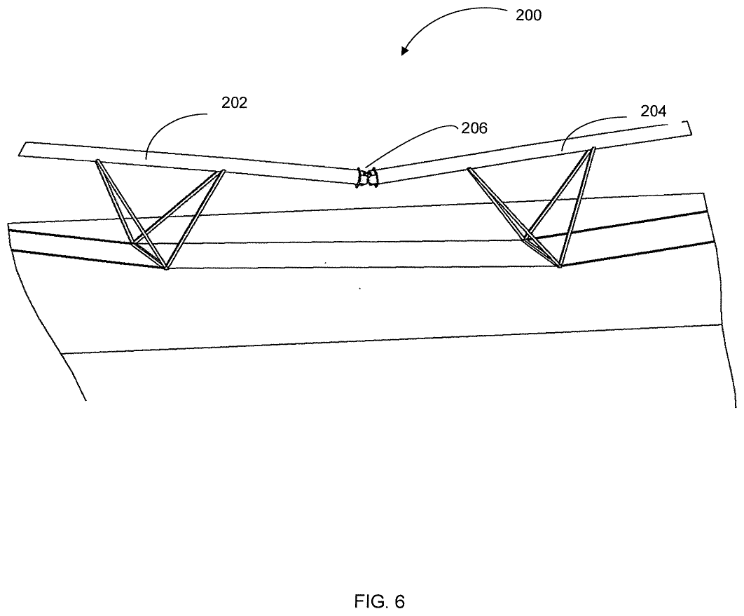

FIG. 5 is an illustration of the exemplary irrigation span 200 with the flexible joint assembly 206 of the present invention in a lowered position. As with upward height adjustments, the lower position may be achieved through control of one or more of the drive towers acting as an SDU, which is controllable to move at a set distance, at a set angle to produce a targeted span height 213. As discussed, this adjustment may be performed via a drive tower controller, which may be controlled directly or via a central controller in response to a targeted span height 213 being selected by an operator. This adjustment may alternatively be made by adjustments to the camber of a given drive wheel for a set time period or travel distance to create or facilitate the targeted height adjustment. FIG. 6 is an enlarged view of the irrigation span 200 with the flexible joint assembly 206 in a lowered position.

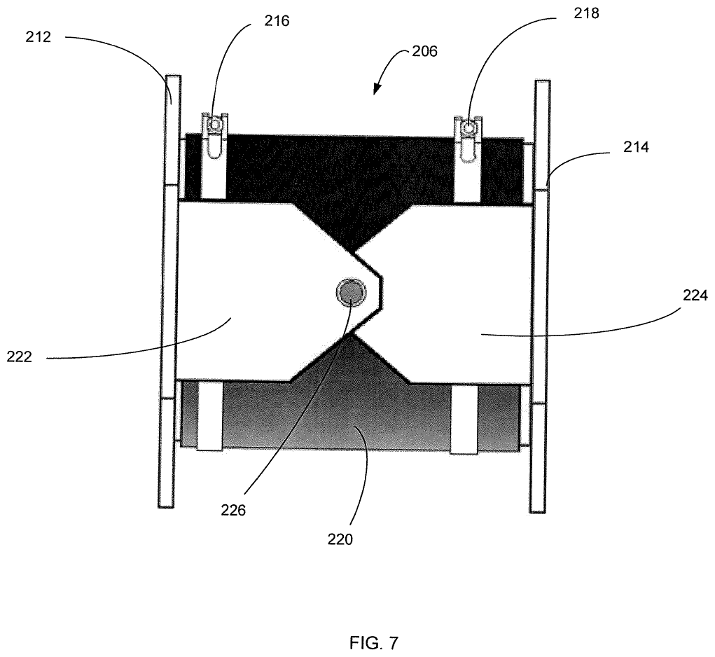

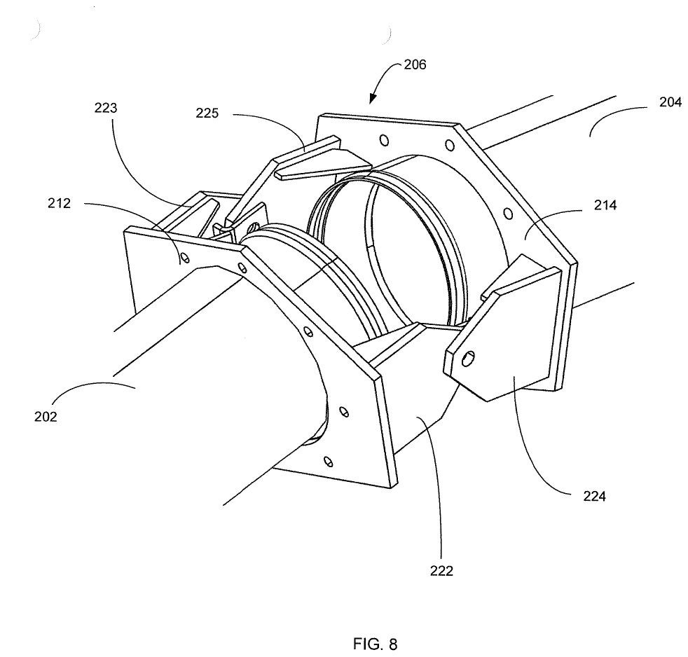

Referring now to FIGS. 7-8, an exemplary flexible joint assembly 206 of the present invention shall now be discussed. As shown in FIGS. 7-8, the flexible joint assembly 206 may preferably include a first flexible joint flange 212 and a second flexible joint flange 214 which are preferably rotationally attached via a pin joint 226 or the like. In operation, when the angular force is applied to one end of the irrigation span or another, the first flexible joint flange 212 and the second joint flange 214 may preferably rotationally move relative to each other around a central attachment point/pin joint 226 to allow flexibility between the spans.

To further facilitate the relative movement between the connected spans 202, 204, the flexible joint assembly 206 preferably may further include a central flexible hose 220 connecting the adjoining sides of adjacent irrigation spans via hose clamps 216, 218 or the like. The flexible hose 220 preferably accommodates fluid transfer, while also providing flexibility to allow the connected irrigation spans to flex relative to each other. As further shown, the flexible joint assembly 206 may preferably further include weldment tabs 222, 224 which preferably provide additional support, ensuring the joint's integrity during adjustments while also facilitating the rotation and flexibility of the connected spans.

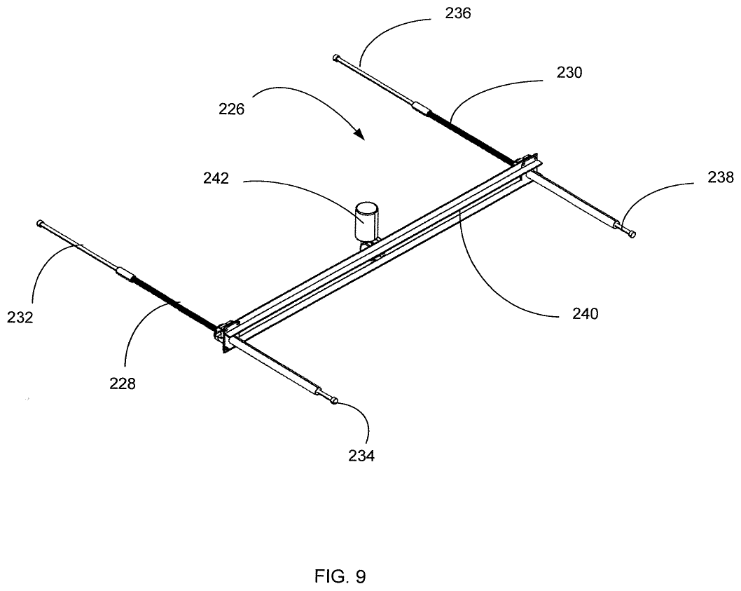

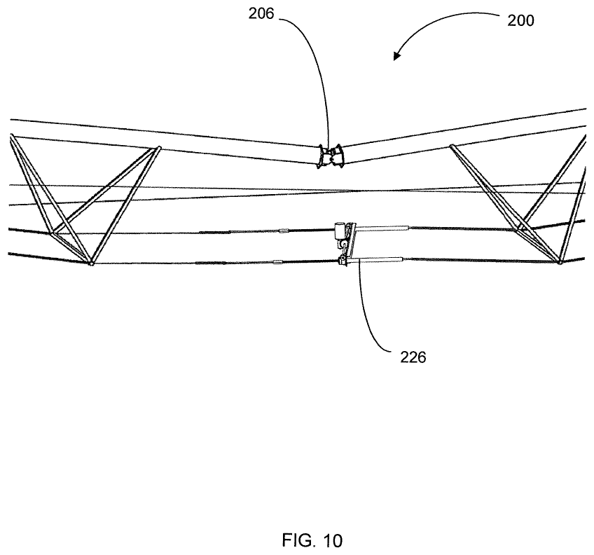

Referring now to FIGS. 9 and 10, the present invention in further embodiments may further include an adjustable turnbuckle assembly 226. As shown in FIG. 9, the adjustable turnbuckle assembly 226 may include truss rods jack screws 228, 230 incorporated between sets of truss rods 232, 234 and 236, 238 which are connectable to further truss rods and other truss elements. As further shown, the adjustable turnbuckle assembly 226 may preferably further include one or more cross members 240.

Additionally, the adjustable turnbuckle assembly 226 may further include a gearmotor 242 which may preferably be mechanically connected to turn the respective jack screws 228, 230 to enable changes in the length of the adjustable turnbuckle assembly 226 in coordination with the height adjustment of the connected spans discussed above.

According to further embodiments, the gearmotor 242 may be remotely controlled to automatically execute incremental adjustments to the adjustable turnbuckle assembly 226 in coordination with selected height adjustments executed by an operator or central controller to raise or lower the connected span sections 202, 204. In this way, the adjustable length truss rod member can be lengthened or shortened to facilitate and/or mechanically assist in the raising and/or lowering of the connected spans. According to preferred embodiments, the adjustable turnbuckle assembly 226 may alternatively incorporate a cable, chain, rod, or other component that is capable of changing the length between truss rod supports such as a hydraulic cylinder or linear actuator. Additionally, a torsional spring, a spring, a cable winch assembly, or the like may also be used to assist the gearmotor 242 and to reduce the maximum torque required from the motor or to assist the turnbuckle assembly in raising and lowering the spans.

The scope of the present invention should be determined not by the embodiments illustrated, but by the appended claims and their legal equivalents.

What is claimed is:

1. An adjustable height irrigation span system, comprising:
a first span and a second span configured for fluid conveyance;
a flexible joint assembly connecting the first span and the second span, the flexible joint assembly comprising:
a first flexible joint flange and a second flexible joint flange rotatably coupled about a central axis to permit relative angular movement;
a flexible hose connecting fluid conduits of the first and second spans to allow fluid transfer while accommodating angular displacement; and
a plurality of hose clamps securing the flexible hose to each respective conduit;
an adjustable turnbuckle assembly operably coupled between truss rods associated with the first and second spans, the turnbuckle assembly comprising jack screws and a motorized actuator configured to modify the height of at least one of the spans.

2. The system of claim 1, wherein the motorized actuator is remotely operable via a central control unit configured to receive manual or automated inputs for span height adjustment.

3. The system of claim 2, wherein the adjustable turnbuckle assembly includes a pair of jack screws connected to opposing truss rods of the first and second spans to facilitate symmetrical height adjustment.

4. The system of claim 3, wherein the flexible joint assembly further comprises weldment tabs connected to the flanges to provide structural support and limit rotational displacement.

5. The system of claim 4, wherein the flexible hose is composed of a high-durability, bend-resistant polymer material configured to maintain fluid integrity during angular displacement.

6. The system of claim 5, wherein the first and second flanges of the flexible joint assembly are rotatably coupled via a removable pin joint.

7. The system of claim 6, wherein the turnbuckle assembly further includes a torsional spring configured to assist the motorized actuator by reducing torque requirements.

8. The system of claim 7, wherein the irrigation span system includes a drive tower for each span, at least one of which comprises a steerable drive unit operable to influence span height through directional movement.

9. The system of claim 8, wherein the flexible joint assembly is configured to provide at least one degree of rotational freedom, including vertical pitch.

10. The system of claim 9, wherein the adjustable height irrigation span system is integrated into a center-pivot or linear move irrigation machine and configured to adapt to varying field topography.

11. The system of claim 1, further comprising a wind-responsive control module configured to automatically lower the span height when wind speeds exceed a predetermined threshold to mitigate structural damage.

12. The system of claim 1, wherein the central control unit is configured to receive location information and adjust the span height based on predefined field topography profiles to prevent crop damage and improve irrigation efficiency.

13. The system of claim 1, wherein the span height is dynamically adjustable during irrigation operations to conform to varying field contours, thereby maintaining optimal irrigation height and minimizing crop interference.

14. The system of claim 1, wherein the flexible joint assembly is positioned at a non-central location along the span to enable localized height adjustment.

15. The system of claim 1, wherein the adjustable turnbuckle assembly comprises a cable winch assembly operable independently of the motorized actuator to modify the span height.

16. A flexible joint assembly for an irrigation span system, comprising:
a first flange and a second flange, wherein the first flange and the second flange are each coupled to a first irrigation span and rotatably connected at a central pivot;
a flexible fluid conduit extending between the spans and secured to each span by a plurality of hose clamps; and
a plurality of weldment tabs supporting the connection between the flanges.

17. The flexible joint assembly of claim 16, wherein the flexible fluid conduit comprises a reinforced elastomeric hose resistant to kinking and capable of sustaining high water pressure during irrigation operations.

18. The flexible joint assembly of claim 17, wherein the weldment tabs are configured to restrict rotational motion beyond a predetermined angular limit to prevent mechanical overstress.

19. The flexible joint assembly of claim 18, wherein the flexible joint assembly permits at least one degree of rotational freedom between the spans.

20. The flexible joint assembly of claim 19, wherein the one degree of rotational freedom comprises a vertical pitch to enable the irrigation spans to adjust over uneven terrain.
